(19) United States
(12) Patent Application Publication
(10) Pub. No.: US 2018/0222780 A1
(43) Pub. Date: Aug. 9, 2018

(54) METHOD OF TREATING WATER USING FOAM FRACTIONATION

(71) Applicant: SYNCRUDE CANADA LTD. in trust for the owners of the Syncrude Project as such owners exist now and in the future, Fort McMurray (CA)

(72) Inventors: RICHARD PAPROSKI, Edmonton (CA); WARREN ZUBOT, Edmonton (CA); SIMON YUAN, Edmonton (CA)

(21) Appl. No.: 15/891,053

(22) Filed: Feb. 7, 2018

Related U.S. Application Data
(60) Provisional application No. 62/456,452, filed on Feb. 8, 2017.

(51) Int. Cl. C02F 1/68; C02F 1/24; C02F 1/28; C02F 3/00

(52) U.S. Cl. CPC C02F 1/68; C02F 1/24; C02F 2101/34; C02F 3/00; C02F 1/283

(57) ABSTRACT

A process for treating oil sands process-affected water containing contaminants, including dissolved organics is provided, comprising: injecting a foaming gas into an oil sands process-affected water to generate an organics-enriched foamate and treated water; and removing the organics-enriched foamate from the treated water to remove contaminants, including at least a portion of the dissolved organics from the treated water.

### FIELD OF THE INVENTION

The present invention relates to a method of treating water using foam fractionation. More particularly, water produced during the recovery of bitumen from oil sands (hereinafter referred to as oil sands process-affected water or OSPW) is treated by foam fractionation to remove contaminants, including dissolved organics, therein.

### BACKGROUND OF THE INVENTION

The demands for water in oil sands operations are high and therefore most operations must rely on recycling process water. However, during oil sands processing, dissolved inorganic (e.g., salts, trace metals) and dissolved organic (e.g., naphthenic acids, other soluble hydrocarbons) constituents are released into process waters. Further, small amounts of dispersed insoluble organics (e.g. bitumen, diluted bitumen, and solvent naphtha) may also be present. Recycling of the oil sands process-affected water (OSPW) reduces the need for fresh water, but can increase contaminant levels, including dissolved inorganic and organic content. Currently, no OSPW is released from the operations.

In order to meet water quality criteria for release, it is necessary to treat the OSPW to reduce contaminants, including dissolved organics such as naphthenic acids and other soluble hydrocarbons. Naphthenic acids have been demonstrated to be toxic to aquatic biota (Alberta Environment Protection. 1996. Naphthenic acids background information discussion report. Edmonton, Alberta, Alberta Environment, Environmental Assessment Division). Thus, the concentration of naphthenic acids present in OSPW must be reduced to levels that are not detrimental to the biological community of a receiving aquatic system. Removal of naphthenic acids may be accomplished with either natural bioremediation or treatment methods to remove them from the OSPW.

Naphthenic acids (NAs) are natural constituents in many petroleum sources, including bitumen in the oil sands of Northern Alberta, Canada. NAs are complex mixtures of predominately low molecular weight (<500 amu), fully saturated alkyl-substituted acyclic and cycloaliphatic (one to more than six rings) carboxylic acids (Brient, J. A., Wessner, P. J., and Doyle, M. N. 1995. Naphthenic acids. In Encyclopedia of Chemical Technology, 4th ed.; Kroschwitz, J. I., Ed.; John Wiley & Sons: New York, 1995; Vol. 16, pp 1017-1029). They can be described by the general empirical formula CₙH_{2n+z}O₂, where n indicates the carbon number and Z is zero or a negative, even integer that specifies the hydrogen deficiency resulting from ring formation (i.e. Z=−2 indicates 1-ring, Z=−4, 2-rings etc.), although naphthenic acid fraction compounds can also include related compounds with somewhat different elemental compositions (e.g. more than 2 oxygen atoms, inclusion of sulfur or nitrogen). While some of naphthenic acids will biodegrade rapidly, a fraction of the naphthenic acids associated with the OSPW have been shown to be more recalcitrant (Scott, A. C., M. D. MacKinnon, and P. M. Fedorak. 2005. Naphthenic acids in Athabasca oil sands tailings waters are less biodegradable than commercial naphthenic acids. ES & T 39: 8388-8394). In order to facilitate release of OSPW, it is desirable to find options for more rapid removal of NAs from OSPW that is both effective and economically viable.

There is a need for an effective, selective and economical water treatment process for the OSPW produced during bitumen oil extraction processes so that the water can be reused in the operation, placed in a reclamation landscape, or released into the environment.

### SUMMARY OF THE INVENTION

The present invention is based on the surprising discovery that foam fractionation can be used to treat process water from oil sands extraction operations to remove contaminants, including at least a portion of dissolved organics. The present invention is particularly effective in treating oil sands process-affected water (OSPW) produced during surface oil sands mining operations.

In one broad aspect of the invention, a process for treating oil sands process-affected water containing contaminants, including dissolved organics, is provided, comprising:
injecting a foaming gas into an oil sands process-affected water to generate an organics-enriched foamate and treated water; and
removing the organics-enriched foamate from the treated water to remove at least a portion of the total organics from the treated water.

### BRIEF DESCRIPTION OF THE DRAWINGS

The present invention, both as to its organization and manner of operation, may best be understood by reference to the following descriptions, and the accompanying drawings of various embodiments wherein like reference numerals are used throughout the several views, and in which:

FIG. 1 is a simplified schematic of an embodiment of the water treatment process of the present invention.

### DESCRIPTION OF THE PREFERRED EMBODIMENTS

The detailed description set forth below in connection with the appended drawings is intended as a description of various embodiments of the present invention and is not intended to represent the only embodiments contemplated by the applicant. The detailed description includes specific details for the purpose of providing a comprehensive understanding of the present invention. However, it will be apparent to those skilled in the art that the present invention may be practiced without these specific details.

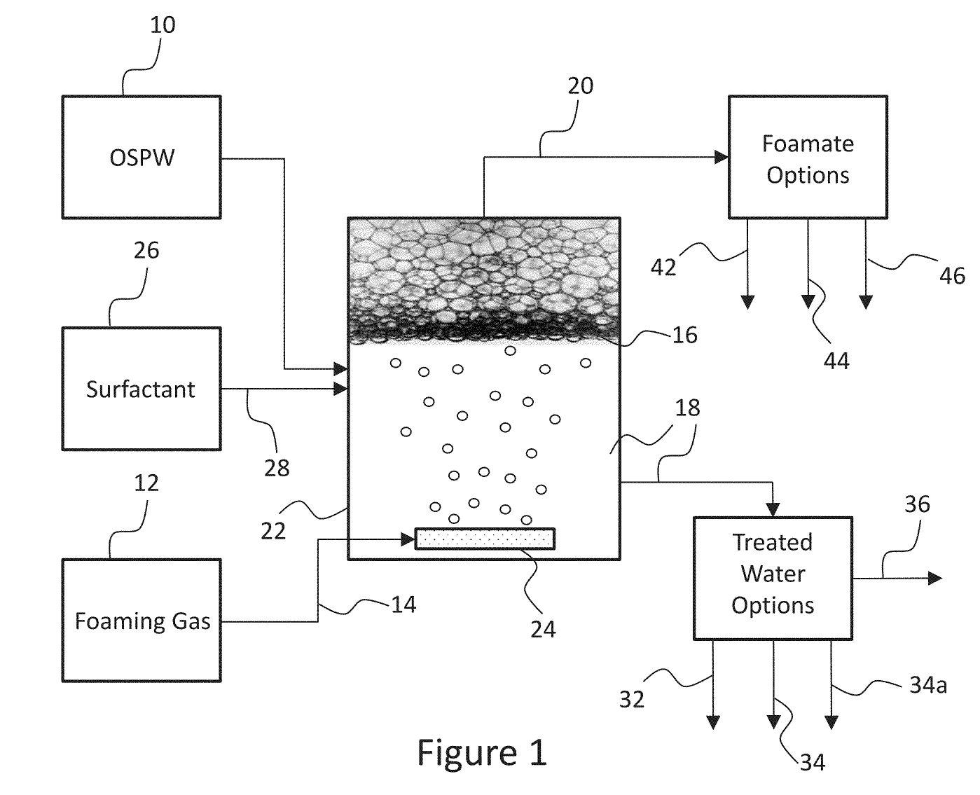

FIG. 1 illustrates schematically a process for treating oil sands process-affected water 10 containing dissolved organics. In the process, a foaming gas 12 is injected 14 to oil sands process-affected water 10 to generate an organics-enriched foamate 16 and treated water 18. In the process, the organics-enriched foamate is removed 20 from the treated water, thereby removing at least a portion of the total organics from the treated water.

The oil sands process-affected water 10 containing organics can be oil sands product water generated during bitumen extraction processes used in either oil sands surface mining or in situ mining operations. For example, but not meaning to be limiting, OSPW can be from obtained from tailings settling basins (fresh release water from extraction tailings), residuals, tailing materials such as clay tailings or froth treatment tailings or from reclamation components (aged OSPW) such as end-pit lakes, sand dyke seepage, etc. Routinely, process water present as the release water for recycle in the settling basins from open pit oil sands operations will contain elevated dissolved organic carbon content (30-70 mgC/L), of which naphthenic acids are the dominant constituent (concentrations range from 30-80 mg/L).

The OSPW may be treated to generate foamate in a foaming reactor 22 which may include components such as a tank or a pipeline. For example, the foaming reactor can be any combination of pipes and vessels that provide sufficient residence time, adequate mixing of the foaming gas and OSPW, very high gas-liquid interface area, and a geometry that promotes separation of the foam and treated water, where the foam has both the time and vertical space to allow excess water to drain away before being collected separately as foamate.

Foamate 16 is generated at least by injecting a foaming gas to the OSPW. Injecting the foaming gas into the OSPW generates gas bubbles in the water, to which the organics and other hydrophobic moieties are attracted. The foaming gas can, for example, be air, CO₂, combustion gases such as stack gases, etc. The potential to use combustion gases as the source of gas for foam fractionation may offer a synergy of potentially reducing gaseous sulfur dioxide emissions, nitrogen oxide emissions, particulate emissions (i.e. opacity), and/or trace metal emissions somewhat similar to wet scrubbing techniques. If SO₂ content is high in the stack gas, the treated water may have a low pH. Equipment for injecting gases to liquid for foaming and equipment for foam collection are available, as will be appreciated. There are a few technologies that may be of use.

1. Flotation: Aeration at atmospheric pressure. Gas is simply introduced in the gas phase directly to the liquid through diffusers. This is illustrated in FIG. 1, wherein injecting 14 may be through a gas line and injection diffuser head 24 into the reactor.

2. DAF: This is called Dissolved or De-compressed Air Flotation (DAF) because the gas actually dissolves into the water at the increased pressure. Injection of the gas while the liquid is under pressure, followed by the release of the pressure.

3. IAF: Induced Air Flotation (IAF) involves saturating the wastewater with gas either directly in an aeration tank or by permitting gas to enter on the suction side of a pump or with a venturi. The partial vacuum, which is applied, causes the dissolved gas to come out of solution as minute bubbles.

4. SAF: Suspended Air Flotation (SAF) is a process where a bubble generator makes bubbles with the use of a surfactant.

In addition to foaming gas, in some embodiments a chemical foaming agent 26 is added 28 to enhance foamate production. The chemical foaming agent may be a surfactant such as one selected from sodium dodecyl sulfate (SDS), dodecylamine (DDA) and methyl isobutyl carbinol (MIBC). SDS, also known as sodium lauryl sulfate, is widely used in consumer cleaning products, cosmetics, pharmaceuticals and food products and is readily biodegradable. Concentrations of surfactant less than about 20 mg/L were found to be useful, for example 5 to 15 mg/L. Where inorganic contaminants such as trace metals have an affinity for the surfactant, partial removal of these dissolved inorganic contaminants from the treated OSPW is possible as well.

Gas injection may be at a rate and maintained for a time suitable to generate foam. Simple testing can show suitable rates and duration for gas injection. In one embodiment, foaming gas injection is less than 1 hour, for example, 1 to 30 minutes. The optimal rate of gas injection will depend on a number of factors, including the geometry of the reactor, the OSPW throughput, the propensity of the OSPW to generate a foam, and whether a given concentration of surfactant(s) is used to promote foam formation.

The present invention is particularly effective in reducing the concentration of naphthenic acids. For example, when using OSPW produced during oil sands mining operations, for example, OSPW from extraction tailings, the method can reduce the naphthenic acid concentration by 5% to more than 50%. The efficiency of dissolved organics removal is dependent on a number of factors including the foaming gas and the chemical foaming agent. The use of carbon dioxide as the foaming gas combined with a chemical additive such as SDS have been found to achieve a 50% reduction in naphthenic acids concentration after foaming for only 10 minutes.

Collected foamate 16 and treated water 18 can be handled in various ways.

The treated water may, for example, be recycled 32 for use as recycle water in further extraction operations or it may require further treatments 34. Alternatively, the treated water can be sent to a holding area or it can be evaluated for suitability for release to the environment 36.

Depending upon the initial dissolved organics concentration of the water, the treated water might require further treatment 34 such as with an advanced oxidation or bioremediation reactor. Thus, additional methods for degradation, ozone treatment, coke treatment or bioremediation of the remaining organics such as naphthenic acids may be required prior to the release of treated water into the environment. In any event, however, foam fractionation may decrease OSPW volumes that require further treatment by more expensive treatment technologies.

In one embodiment, for example, there is also a potential to combine foam fractionation with coke treatment for naphthenic acid reduction in OSPW. Coke treatment is described in applicant's prior U.S. Pat. No. 7,638,057 and includes contact of the OSPW with petroleum coke for a residence time. In particular, using petroleum coke from a coking operation, a petroleum coke/water slurry is formed by adding the water to be treated to the petroleum coke. The slurry is mixed for a sufficient time in a carbon adsorption reactor to allow the petroleum coke to adsorb a substantial portion of the dissolved organics from the water. The reactor may be a stirred reaction tank, a pipeline, or a stationary coke bed that the OSPW is passed through. In one embodiment, OSPW can be treated by foam fractionation as described above and then the treated water can be passed for coke treatment 34a. The preliminary foam fractionation may reduce the total coke treatment time or may achieve a more significant naphthenic acid reduction. In particular, there may be a synergy of combining foam fractionation with CO₂ followed by petroleum coke adsorption to reduce the naphthenic acid concentration in the treated water beyond what can be achieved by foam fractionation or coke treatment alone, and/or to reduce the contact time between petroleum coke and OSPW to achieve a given reduction in naphthenic acid concentration.

Also, there may be a potential to combine foam fractionation with clay flotation to remove both clays and naphthenic acids at the same time. By adjusting the conditions for clay flotation to coincide with those favorable for foam fractionation of OSPW, both clays and some organics can be removed simultaneously from tailings materials. This may result in an enrichment of naphthenic acids and other organics in the clay froth, while resulting in lower amounts of contaminants in the mixture of treated water and silt produced by clay flotation.

As noted above, the treated water may initially have a pH unsuitable for further operations or release. For example, foaming with CO₂ or combustion gases high in SO₂ may cause the treated water to have an acidic pH. However, adsorption 34a onto petroleum coke is enhanced at lower pH. If necessary, however, pH may be adjusted. For example, addition of caustic or lime may be used to quickly return the pH above 7. Alternatively, thorough aeration may be used to allow excess CO₂ to be released. Aeration can also be used to oxidize sulfite to sulfate if stack gases containing SO₂ are used as the foaming gas.

The foamate 16 may be recycled 42 for use in other operations, further treated 44 for reclamation or sent to a holding area 46. In one embodiment, for example, there is a potential to recycle 42 the collected foamate back to bitumen extraction for potential improvements in bitumen recovery and/or froth quality. Foamate 16 contains naphthenic acids and potentially other surfactants which may enhance bitumen recovery and/or froth quality.

In another embodiment, foamate 16 may be treated 44 by additional methods for degradation, ozone treatment, coke treatment or bioremediation of the organics, potentially reducing the total volumes requiring such treatment.

### Examples

Summary:

OSPW from Syncrude Operations was foam fractionated in a 250 mL graduated cylinder using either air or carbon dioxide. Samples of the untreated OSPW, foam-treated OSPW, and recovered foamate were analyzed for NA concentrations, pH, and conductivity. The effects of using ˜10 mg/L of either SDS, MIBC, or DDA additives were also tested.

Results/Conclusions:

Carbon dioxide with SDS was the most effective, producing 50% lower NA concentrations in the treated OSPW. MIBC or DDA with carbon dioxide were similarly effective with 45% and 47% reductions respectively. Without an additive, carbon dioxide reduced NA concentrations by 31-36%. The use of carbon dioxide led to lowered initial pH values of 5.7-6.5 while conductivity was unaffected. The use of air reduced NA concentrations by 7-26%.

Procedure

A 250 mL graduated cylinder was placed inside a 2 L beaker. Gases were delivered to the bottom of the cylinder through a porous stainless steel sparger connected to plastic tubing. The sparger helped to produce numerous small bubbles to increase the total gas/water interface surface area and promote foam production.

1. OSPW was poured into the 250 mL cylinder. For the tests #1-6, 250 mL was used. For tests #7-12, 290 g was used, to improve the accuracy of the measurements.

2. The stainless steel sparger was secured in position at the bottom of the cylinder.

3. For tests where an additive was used, either SDS, DDA (as the HCl salt), or MIBC was initially dissolved in water to create a fully dissolved concentrated solution, which was then added to the OSPW to create a working concentration of ˜10 mg/L.

4. Either a fixed or variable amount of gas flow was delivered to the cylinder. In the case of variable gas flow, the goal was to produce a slow but steady amount of foam throughout the test.

5. Foam was allowed to overflow the cylinder and was collected in the 2 L beaker.

6. The gas flow was maintained for either 1 or 10 minutes. The gas flow was briefly increased at the end of the test for 10 seconds to raise the water/foam interface to help overflow any remaining stable foam into the 2 L beaker.

7. For tests #1-6, the volume of the “treated” process water that remained in the cylinder was measured. For tests #7-12, the weight of the “treated” process water and weight of the recovered foamate were measured. Evaporative losses for tests #7-12 were measured to be 0.3-1.1%.

8. Samples of the “treated” water and the foamate were analyzed for naphthenic acid determination, pH, and conductivity.

Calculations

1. % Naphthenic acid (NA) concentration reductions were calculated simply as the original concentration of NA's source OSPW minus the treated process water concentration, divided by the original source NA concentration.

2. % NA recovered in the foamate was calculated as the calculated mass of NA's in the foamate, divided by the total of the calculated mass of the NA's in the foamate plus the calculated mass of the NA's in the treated OSPW.

Results and Discussion

Table 1 shows the results of using either air or carbon dioxide as the foaming gas, without the aid of any chemical additives to promote foam formation. For each gas, three different gas flow rates were tested. The challenge with using a fixed gas flow rate is that the higher flow rates of 0.6 and 1.0 L/min resulted in a very wet foam (i.e. foam diluted with bulk water) overflowing the cylinder, while the lower flow rate of 0.4 L/min produced a more desirable drier foam that initially overflowed the cylinder, but then stopped overflowing before the end of the test duration. The use of the higher flow rates led to significant volumes of material overflowing and reporting as foamate. A more desirable outcome would be where only a small fraction of the material overflows and reports as foamate, provided that significant NA concentration reductions in the treated water can still be achieved.

The use of carbon dioxide reduced NA concentrations in the treated water by 31-36% and resulted in NA recoveries in the foamate of 39-58% when no additives were used. The use of carbon dioxide also resulted in lower pH values for both the treated waters and foamates. The use of air resulted in poorer NA reductions of 7.1-9.5% and NA recoveries of 15-37% when no additives were used.

Table 2 shows the second set of preliminary results where different chemical additives were tested for their ability to promote foam formation and improve NA recoveries. Because it became difficult to predict the right amount of gas flow to produce a slow and steady amount of dry foam when different additives were used, the fixed gas flow rate was abandoned part way through the second set of tests. Instead, the gas flow was adjusted throughout each test (<1 L/min) in an effort to produce a slow and steady amount of foam. Both SDS and MIBC initially produced a somewhat wet foam which transitioned to a drier foam during the testing. DDA produced a mostly wet foam that exhibited relatively poor foam stability compared to SDS and MIBC. The more stable foam produced by SDS in particular allowed better control of the test, where only ˜¼ of the material reported as foamate with carbon dioxide compared to ˜½ of the material when MIBC or DDA were used with carbon dioxide.

The use of carbon dioxide with additives produced NA reductions in the treated water of 45-50% and NA recoveries in the foamate of 56-77%. Even with additives, the use of air resulted in lower NA reductions of 7.9-26% and NA recoveries of 48-64%. The combination of carbon dioxide, adjustable foaming gas flow rate, and an additive such as SDS, is necessary to achieve a high NA reduction (e.g. 50%) and relatively small volume of produced foamate (e.g. 25%).

More elaborate foam fractionation equipment that provides more vertical space would allow a wet foam to drain away more excess water before foamate collection. This could result in a smaller volume of collected foamate with a potentially higher NA concentration.

TABLE 1
First foam fractionation test results (no chemical additives).

| | | | | | | | | | Treated | Foamate |
|---|---|---|---|---|---|---|---|---|---|---|
| | | | Gas | | Final | | | Naphthenic | Water NA | NA |
| Test | Sample | | Flow | Time | Volume* | | Conductivity | Acids | Reduction | Recovery |
| # | Type | Gas | (L/min) | (min) | (mL) | pH | (mS/cm) | (mg/L) | (%) | (%) |
| N/A | Original | N/A | N/A | N/A | N/A | 7.87 | 2.99 | 42 | N/A | N/A |
| | OSPW | | | | | | | | | |
| 1 | Treated | Air | 1 | 1 | 170 | 8.16 | 2.98 | 38 | 9.5 | N/A |
| | Water | | | | | | | | | |
| 1 | Foamate | Air | 1 | 1 | N/A | 8.13 | 2.96 | 48 | N/A | 37 |
| 2 | Treated | Air | 0.6 | 1 | 180 | 8.02 | 2.97 | 38 | 9.5 | N/A |
| | Water | | | | | | | | | |
| 2 | Foamate | Air | 0.6 | 1 | N/A | 8.14 | 2.96 | 34 | N/A | 26 |
| 3 | Treated | Air | 0.4 | 10 | 230 | 8.16 | 2.95 | 39 | 7.1 | N/A |
| | Water | | | | | | | | | |
| 3 | Foamate | Air | 0.4 | 10 | N/A | 8.53 | 2.96 | 81 | N/A | 15 |
| 4 | Treated | CO₂ | 1 | 1 | 133 | 6.54 | 3.00 | 29 | 31 | N/A |
| | Water | | | | | | | | | |
| 4 | Foamate | CO₂ | 1 | 1 | N/A | 6.65 | 3.00 | 46 | N/A | 58 |
| 5 | Treated | CO₂ | 0.6 | 1 | 186 | 6.24 | 2.99 | 29 | 31 | N/A |
| | Water | | | | | | | | | |
| 5 | Foamate | CO₂ | 0.6 | 1 | N/A | 6.81 | 2.99 | 55 | N/A | 40 |
| 6 | Treated | CO₂ | 0.4 | 10 | 195 | 6.14 | 2.99 | 27 | 36 | N/A |
| | Water | | | | | | | | | |
| 6 | Foamate | CO₂ | 0.4 | 10 | N/A | 6.93 | 2.99 | 73 | N/A | 43 |

*Initial untreated water volume was 250 mL. For these tests, the foamate volume was not recorded, but was calculated by difference.

TABLE 2
Second foam fractionation test results (with chemical additives).

| | | | | | | | | | | | Treated | Foamate |
|---|---|---|---|---|---|---|---|---|---|---|---|---|
| | | | | Gas | | Initial | Final | | | Naphthenic | Water NA | NA |
| Test | Sample | Additive | | Flow | Time | Weight | Weight | | Cond. | Acids | Reduction | Recovery |
| # | Type | (mg/L) | Gas | (L/min) | (min) | (g) | (g) | pH | (mS/cm) | (mg/L) | (%) | (%) |
| N/A | Original | N/A | N/A | N/A | N/A | N/A | N/A | 7.61 | 2.84 | 38 | N/A | N/A |
| | OSPW | | | | | | | | | | | |
| 7 | Treated | SDS | Air | 0.4 | 10 | 291.6 | 167.2 | 7.71 | 2.86 | 35 | 7.9 | N/A |
| | Water | 9.2 mg/L | | | | | | | | | | |
| 7 | Foamate | SDS | Air | 0.4 | 10 | N/A | 123.4 | 7.72 | 2.88 | 43 | N/A | 48 |
| | | 9.2 mg/L | | | | | | | | | | |
| 8 | Treated | MIBC | Air | 0.6 | 10 | 294.6 | 150.4 | 7.98 | 2.88 | 32 | 16 | N/A |
| | Water | 9.4 mg/L | | | | | | | | | | |
| 8 | Foamate | MIBC | Air | 0.6 | 10 | N/A | 141.6 | 7.48 | 2.86 | 49 | N/A | 59 |
| | | 9.4 mg/L | | | | | | | | | | |
| 9 | Treated | DDA | Air | Variable* | 10 | 293.2 | 142.3 | 8.78 | 2.88 | 28 | 26 | N/A |
| | Water | 9.2 mg/L | | | | | | | | | | |
| 9 | Foamate | DDA | Air | Variable* | 10 | N/A | 147.7 | 8.44 | 2.88 | 49 | N/A | 64 |
| | | 9.2 mg/L | | | | | | | | | | |
| 10 | Treated | SDS | CO₂ | Variable* | 10 | 294.8 | 221.2 | 5.69 | 2.89 | 19 | 50 | N/A |
| | Water | 9.1 mg/L | | | | | | | | | | |
| 10 | Foamate | SDS | CO₂ | Variable* | 10 | N/A | 72.5 | 6.84 | 2.91 | 74 | N/A | 56 |
| | | 9.1 mg/L | | | | | | | | | | |
| 11 | Treated | MIBC | CO₂ | Variable* | 10 | 291.5 | 142 | 5.79 | 2.89 | 21 | 45 | N/A |
| | Water | 9.5 mg/L | | | | | | | | | | |
| 11 | Foamate | MIBC | CO₂ | Variable* | 10 | N/A | 147.5 | 6.14 | 2.90 | 52 | N/A | 72 |
| | | 9.5 mg/L | | | | | | | | | | |
| 12 | Treated | DDA | CO₂ | Variable* | 10 | 292 | 122.3 | 5.81 | 2.87 | 20 | 47 | N/A |
| | Water | 9.3 mg/L | | | | | | | | | | |
| 12 | Foamate | DDA | CO₂ | Variable* | 10 | N/A | 167.2 | 5.94 | 2.88 | 48 | N/A | 77 |
| | | 9.3 mg/L | | | | | | | | | | |

*<1 L/min, adjusted to produce a slow but steady amount of foam throughout the test.

While the invention has been described in conjunction with the disclosed embodiments, it will be understood that the invention is not intended to be limited to these embodiments. On the contrary, the current protection is intended to cover alternatives, modifications and equivalents, which may be included within the spirit and scope of the invention. Various modifications will remain readily apparent to those skilled in the art.

What is claimed is:

1. A process for treating oil sands process-affected water containing contaminants, including dissolved organics, is provided, comprising:
injecting a foaming gas into an oil sands process-affected water to generate an organics-enriched foamate and treated water; and
removing the organics-enriched foamate from the treated water to remove contaminants, including at least a portion of the dissolved organics, from the treated water.

2. The process as claimed in claim 1, wherein the oil sands process-affected water is from an oil sands extraction operation.

3. The process as claimed in claim 2, wherein the oil sands extraction operation is a surface mining operation.

4. The process as claimed in claim 1, wherein the foaming gas is CO₂.

5. The process as claimed in claim 1, wherein the foaming gas is a combustion or stack gas.

6. The process as claimed in claim 1, further comprising:
adding a surfactant to the oil sands process-affected water.

7. The process as claimed in claim 6, wherein the surfactant is one selected from sodium dodecyl sulfate (SDS), dodecylamine (DDA) and methyl isobutyl carbinol (MIBC).

8. The process as claimed in claim 6, wherein the foaming gas is CO₂ or a combustion or stack gas and the surfactant is SDS.

9. The process as claimed in claim 1, further comprising:
recycling the foamate to a bitumen extraction operation.

10. The process as claimed in claim 1, further comprising:
treating the foamate by petroleum coke adsorption.

11. The process as claimed in claim 1, further comprising:
subjecting the foamate to biodegradation in a biological reactor or degradation by advanced oxidation methods.

12. The process as claimed in claim 1, further comprising:
treating the treated water by petroleum coke adsorption.

13. The process as claimed in claim 1, further comprising:
subjecting the treated water to biodegradation in a biological reactor or degradation by advanced oxidation methods.

14. The process as claimed in claim 1, further comprising:
adjusting the conditions of a clay flotation tailings treatment to promote the enrichment of contaminants, including dissolved organics, in the foamate.
